(19) United States
(12) Patent Application Publication
(10) Pub. No.: US 2017/0100731 A1
(43) Pub. Date: Apr. 13, 2017

(54) SHOWER HEAD ASSEMBLY WITH AIR HOLES

(71) Applicant: KUN-CHIH CHEN, Changhua (TW)

(72) Inventor: KUN-CHIH CHEN, Changhua (TW)

(73) Assignee: SUNRISE SHOWER PRODUCTS CO., LTD., CHANGHUA (TW)

(21) Appl. No.: 14/878,303

(22) Filed: Oct. 8, 2015

(51) Int. Cl. B05B 7/04; B05B 15/06; E03C 1/02; B05B 1/18

(52) U.S. Cl. CPC B05B 7/0425; B05B 1/18; B05B 15/061; E03C 1/021

(57) ABSTRACT

A shower head assembly with air holes may include a connector, a mixing unit, an adapter unit and a shower head. Since the diameter of the through hole is larger than the first connecting hole, the air holes can be covered to prevent the air holes from being exposed outside of the shower head assembly. Thus, it not only improves the appearance of the shower head, but also prevents the air holes from blocking by dust or other stuff. Also, with the design of the connector, the mixing unit combining the adapter unit, the shower head assembly of the present invention can apply in both the fixed shower head and the handheld shower head to improve the application of the shower head assembly.

### FIELD OF THE INVENTION

The present invention relates to a shower head assembly with air holes, and more particularly to a shower head assembly with air holes that can be applied in both handheld shower head and fixed shower head.

### BACKGROUND OF THE INVENTION

Since conventional shower head assemblies in market cannot be effective to limit the flow of water, a shower head assembly with air hole and quick connector is disclosed in my previous invention. Referring to FIGS. 8 and 9, or Taiwanese Patent No.M387627, a conventional shower head assembly comprises a sleeve (60), a quick connector (70), and a shower head (80). The sleeve (60) is a stepped hollowed cylinder, and the hollowed portion formed inside of the sleeve (60) is configured as a flowing channel (61). An outer wall of the sleeve (60) has two first air holes (62), which are at relative positions, and a first engaging portion (63), and the two first air holes (62) penetrate the outer wall to connect with the flowing channel (61). The quick connector (70) comprises a through hole (71) axially penetrating along a central portion of the quick connector (70), and a first threaded section (72) formed at an inner periphery of an opening of the quick connector (70) is located above the through hole (71) to receive water source. A water outlet (73) formed at a bottom portion of the quick connector (70) has a diameter which is smaller than a diameter of the quick connector (70), and an outer periphery of the water outlet (73) has a second threaded section (74). Two second air holes (75) formed at an outer periphery of quick connector (70) are located at positions corresponding to the through hole (71), and two groove-shaped second engaging portions (76) are formed at relative positions inside of the through hole (71). The shower head (80) comprises a main body (81), and a handle (82) is formed at an outer periphery of the main body (81). A ball joint tube (83) is connected with a top portion of the main body (81), and an inner periphery of a top portion of the ball joint tube (83) has an inner threaded section (84). The sleeve (60) is secured inside of the quick connector (70) by engaging the first engaging portion (63) with the second engaging portion (76) of the quick connector (70), and the two first air holes of the sleeve (60) are respectively aligned with the two second air holes (75) of the quick connector (70). The quick connector (70) is connected to the shower head (80) by engaging the second threaded section (74) with the inner threaded section (84). When the shower head assembly is in use, the water flows from the through hole (71) through the water outlet (73), insides of the inner threaded section (84) and the ball joint tube (83), and gushes out of shower head (80) from the main body (81). Also, because of the design of the first air holes (62) on the sleeve (60) and the second air holes (75) on the quick connector (70), an air in the atmosphere can be sucked into the shower head assembly to prevent an inside of the shower head (80) from becoming a vacuum state. The inhaled air also can scatter the water in the shower head (80), so the water gushed out of the shower head can be in the form of water column with water spray. Thus, the range of water sprayed from the shower head (80) is wider, and the shower head assembly can be more effective to achieve the purpose of water-saving.

However, the conventional shower head assembly is disadvantageous because: (i) the second air holes (75) is formed at an outer wall of the shower head assembly, so that the second air holes (75) are more likely to be congested by dust or other items. As a result, the air in the atmosphere will be not able to suck into the shower head assembly, leading to lowering the effect of the saving-water; and (ii) the quick connector (70) can only be applied in the fixed shower head (80), instead of the handheld shower head. Therefore, there remains a need for a new and improved design for a shower head assembly to overcome the problems presented above.

### SUMMARY OF THE INVENTION

The present invention provides a shower head assembly with air hole, which comprises a connector, a mixing unit, an adapter unit and a shower head. The connector has a first connecting hole axially penetrating through a central portion of the connector, and a connecting portion is formed at a first end of the connector to connect to the water source. A through hole extending from the connecting hole is formed at a second end of the connector, and a diameter of the through hole is larger than the connecting hole. The mixing unit comprises a hollowed mixing body to allow a pipe to axially penetrate through a central portion of the mixing body, and a water channel is formed inside of the pipe. At least two air holes penetrates two relative positions of an outer periphery of the mixing body to connect to the water channel, and a first end of the pipe is stuck out from a first end of the mixing body. Also, a first engaging portion is formed at the first end of the mixing unit, and a second engaging portion is formed at a second end thereof. In assembly process, the first engaging portion of the mixing unit is engaged with the adapter unit to secure the pipe inside of the adapter unit, and then the second engaging portion is secured inside of the connecting hole to connect the mixing unit to the connector. Since the diameter of the through hole is larger than the first connecting hole, the air holes can be covered to prevent the air holes from being exposed outside of the shower head assembly. A second connecting hole axially penetrates a central portion of the adapter unit to connect the adapter unit with the shower head and the mixing unit with the connector. Since the pipe protrudes from the adapter unit after connecting the mixing unit with the connector to the adapter unit, the water channel can be connected to an inner water channel of the shower head.

Comparing with conventional shower head assembly, the present invention is advantageous because: (i) since the diameter of the through hole is larger than the first connecting hole, the air holes can be covered to prevent the air holes from being exposed outside of the shower head assembly. Thus, it not only improves the appearance of the shower head, but also prevents the air holes from blocking by dust or other stuff; and (ii) with the design of the connector, the mixing unit combining the adapter unit, the shower head assembly of the present invention can apply in both the fixed shower head and the handheld shower head to improve the application of the shower head assembly.

### BRIEF DESCRIPTION OF THE DRAWINGS

FIG. 1 is a three-dimensional assembly of the shower head assembly with air hole in present invention.

FIG. 2 is a three-dimensional, exploded view of the shower head assembly with air hole in present invention.

FIG. 3 is a sectional assembly of the shower head assembly with air hole in present invention.

FIG. 4 is a schematic view of the shower head assembly with air hole in present invention, when the water flows inside thereof.

FIG. 5 is a schematic view of the replacing process of the shower head assembly with air hole in present invention applied in a common handheld shower head assembly.

FIG. 6 is a three-dimensional, exploded view of another embodiment of the shower head assembly with air hole in present invention.

FIG. 7 is a sectional assembly of another embodiment of the shower head assembly with air hole in present invention.

FIG. 8 is a prior art.

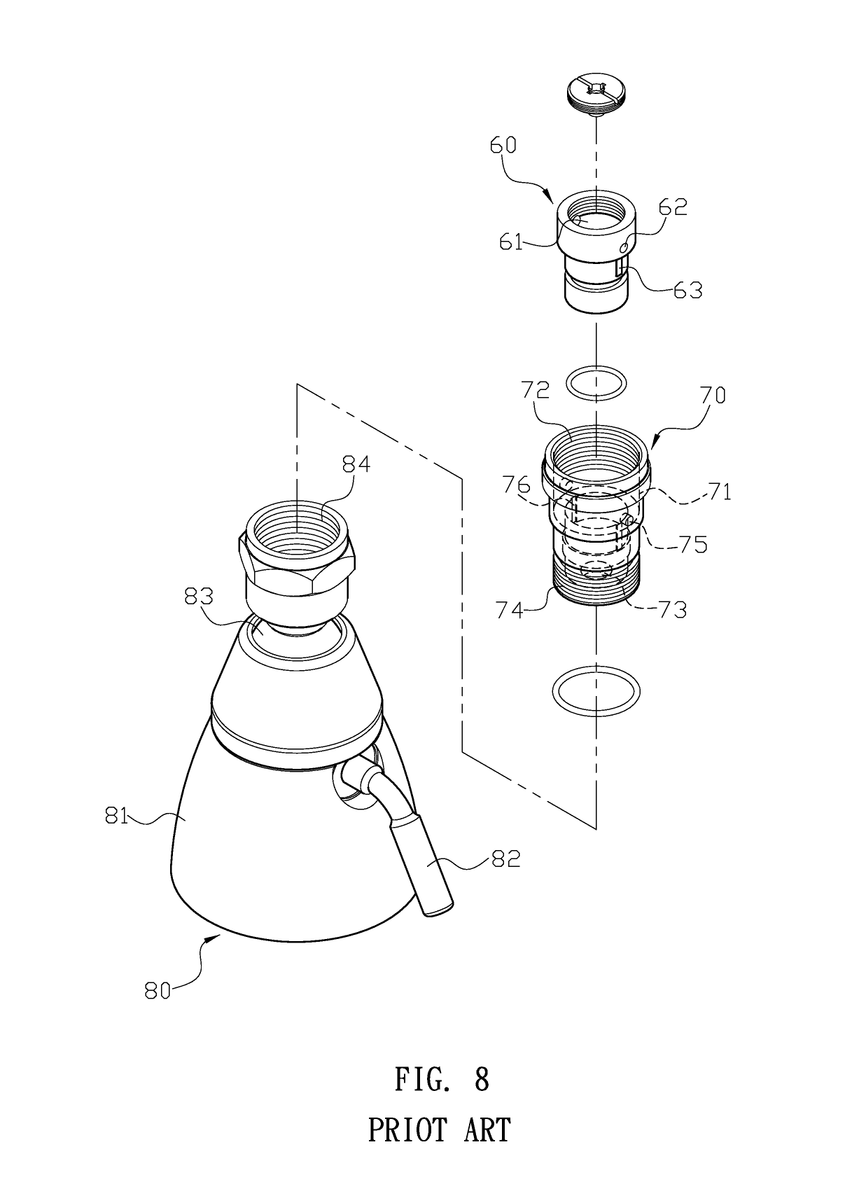

FIG. 9 is a prior art.

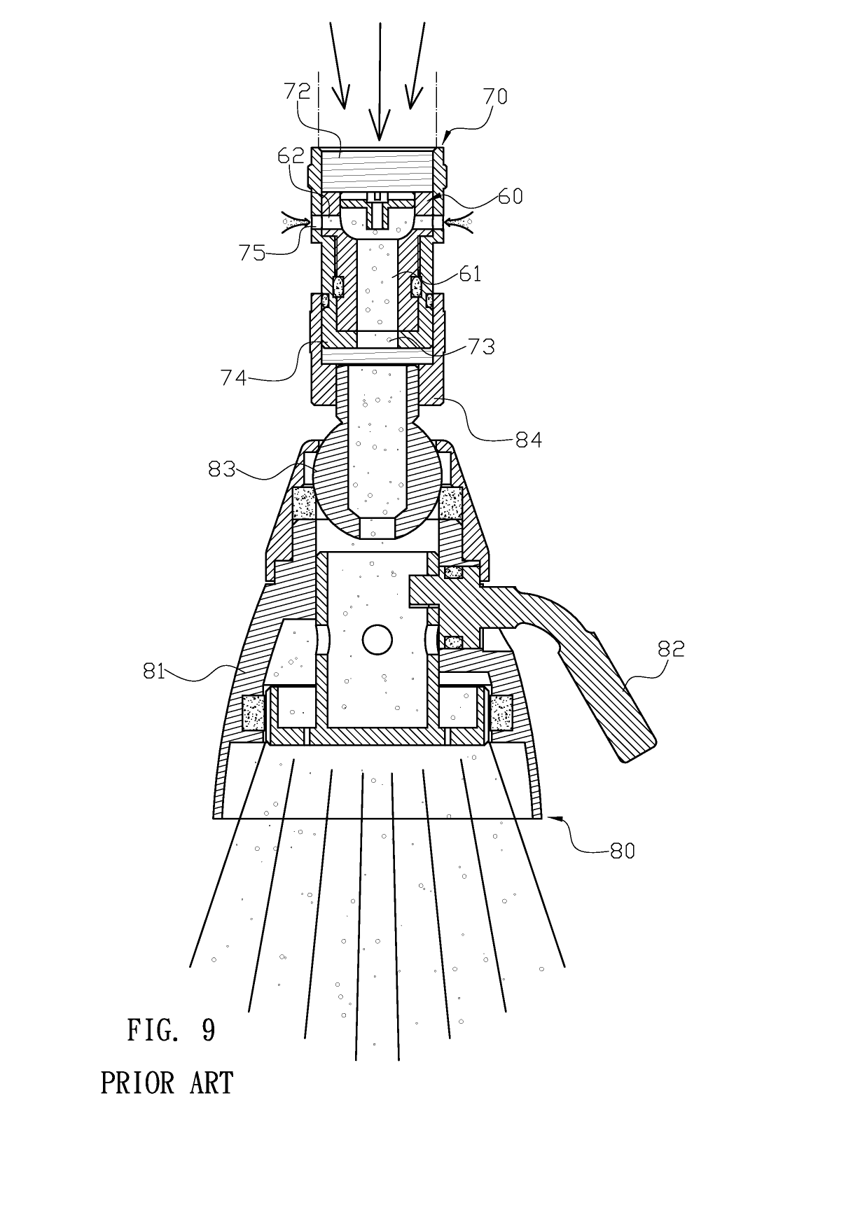

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

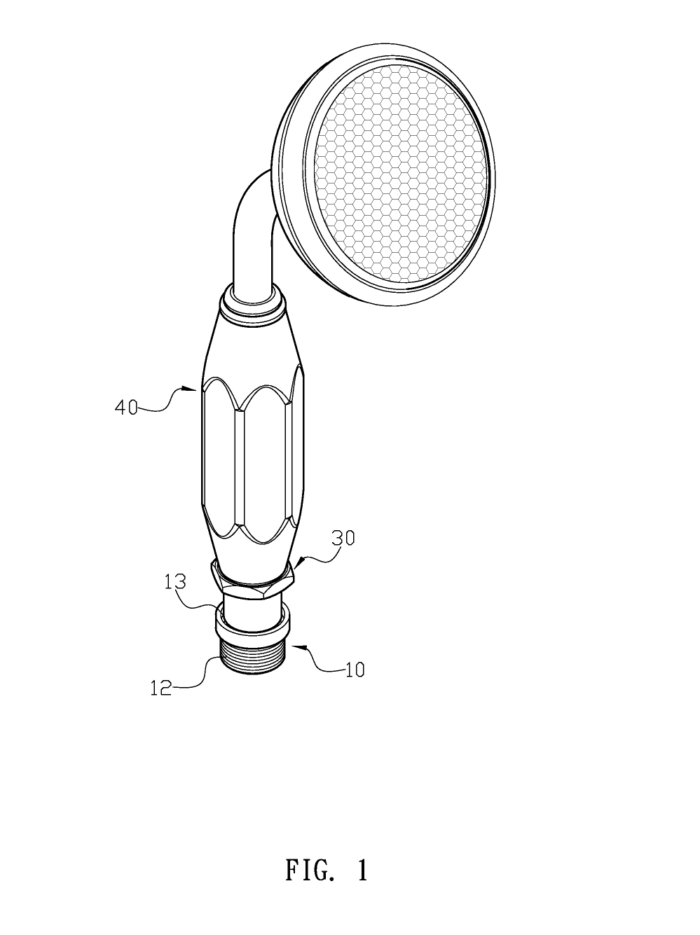

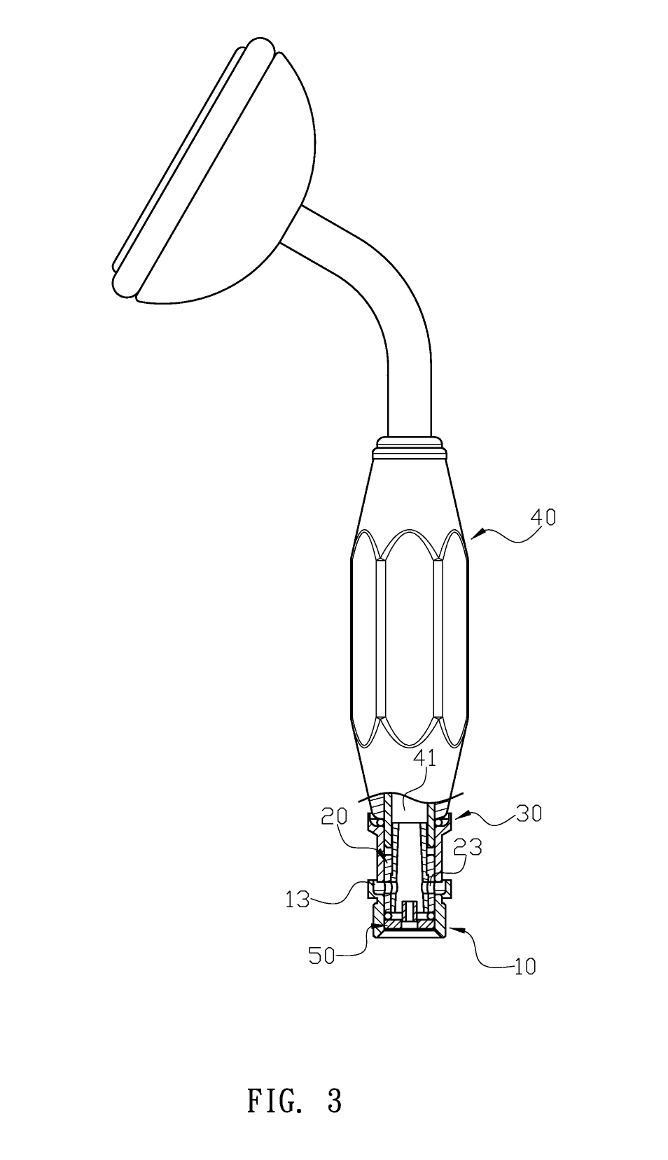

Referring to FIGS. 1 and 3, the present invention provides a shower head assembly with air holes, which comprises a connector (10), a mixing unit (20), an adapter unit (30) and a shower head (40). The connector (10) has a first connecting hole (11) axially penetrating through a central portion of the connector (10), and an connecting portion (12) is formed at a first end of the connector (10) to connect to the water source. A through hole (13) extending from the connecting hole (11) is formed at a second end of the connector (10), and a diameter of the through hole (13) is larger than the connecting hole (11). The mixing unit (20) comprises a hollowed mixing body (21) to allow a pipe (22) to axially penetrate through a central portion of the mixing body (21), and a water channel (221) is formed inside of the pipe (22). At least two air holes (23) penetrates two relative positions of an outer periphery of the mixing body (21) to connect to the water channel (221), and a first end of the pipe (22) is stuck out from a first end of the mixing body (21). Also, a first engaging portion (24) is formed at the first end of the mixing unit (20), and a second engaging portion (25) is formed at a second end thereof. In assembly process, the first engaging portion (24) of the mixing unit (20) is engaged with the adapter unit (30) to secure the pipe (22) inside of the adapter unit (30), and then the second engaging portion (25) is secured inside of the connecting hole (11) to connect the mixing unit (20) to the connector (10). Since the diameter of the through hole (13) is larger than the first connecting hole (11), the air holes (23) can be covered to prevent the air holes (23) from being exposed outside of the shower head assembly. A second connecting hole (31) axially penetrates a central portion of the adapter unit (30) to connect the adapter unit (30) with the shower head (40) and the mixing unit (20) with the connector (10). Since the pipe (22) protrudes from the adapter unit (30) after connecting the mixing unit (20) with the connector (10) to the adapter unit (30), the water channel (221) can be connected to an inner water channel (41) of the shower head (40).

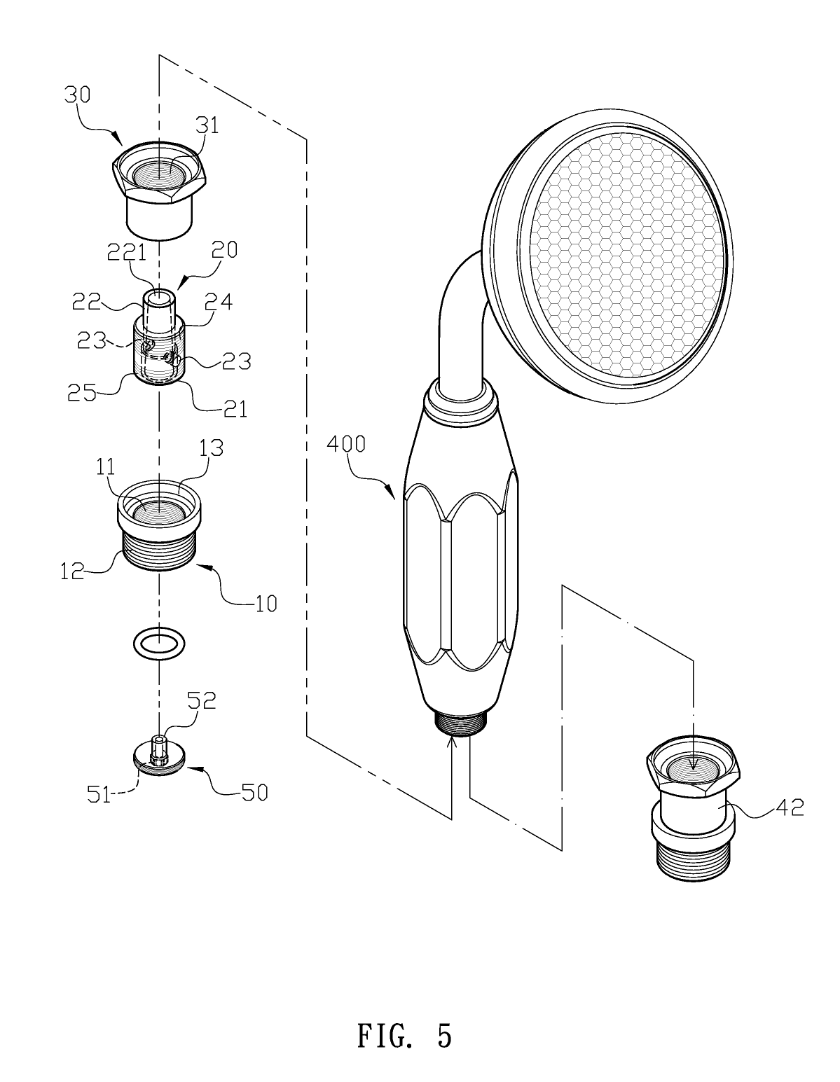

In one embodiment, the shower head (40) of the present invention can be applied in a handheld shower head assembly. Referring to FIGS. 1 to 4, the first engaging portion (24) of the mixing unit (20) is a threaded section formed at the outer periphery of the mixing body (21), and the second connecting hole (31) of the adapter unit (30) also comprises a threaded section at an inner periphery thereof to engage with the handheld shower head and the first engaging portion (24) of the mixing unit (20). Thus, the mixing unit (20) with the connector can connect to the handheld shower head through the adapter unit (30). In assembly process, a user can disengage a tube connector (42) from a common handheld shower head (400), and then the mixing unit (20) with the connector (10) in the present invention can be connected to the handheld shower head (400) through the adapter unit (30) to finish the assembly process (as shown in FIG. 5).

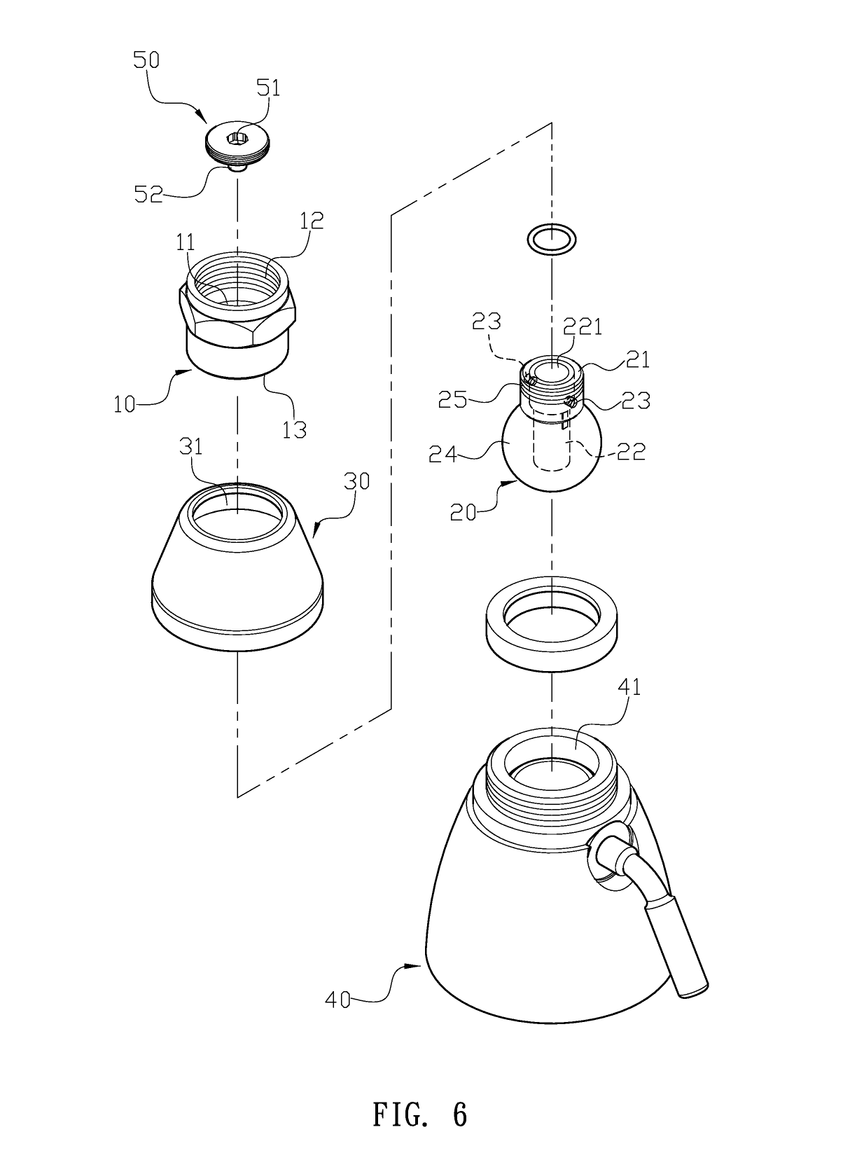

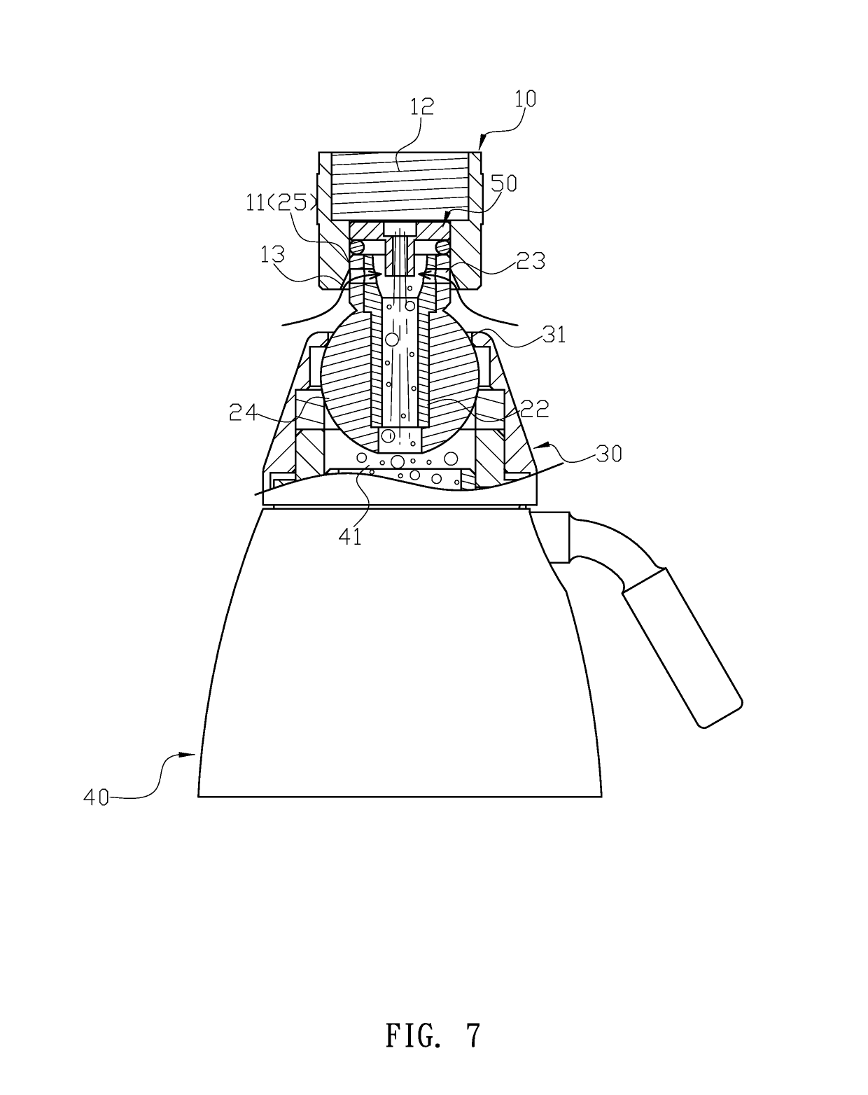

In another embodiment, the shower head (40) of the present invention can be applied in a fixed shower head assembly. Referring to FIGS. 6 to 7, the first engaging portion (23) is a ball body secured around the pipe (22) to connect to the second connecting hole (31) of the adapter unit (30). Moreover, the threaded section inside of the connecting hole (31) is engaged with the fixed shower head, so that the mixing unit (20) with the connector (10) in the present invention can be connected to the fixed shower head through the adapter unit (30).

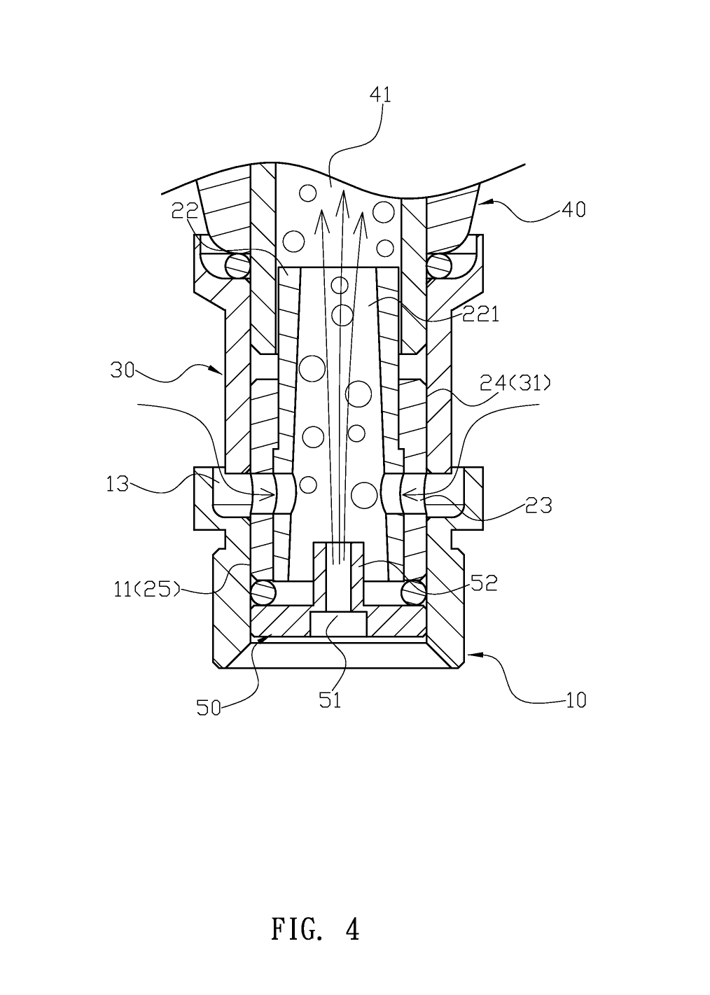

In still another embodiment, the through hole (13) of the connector (10) is shaped into a stepped shape (as shown in FIGS. 3 and 4).

In a further embodiment, the through hole (13) of the connector (10) is shaped into a tapered shape (as shown in FIG. 7).

In still a further embodiment, a diameter of an inlet of the water channel (221) is larger than an outlet thereof to form a tapered water channel (221).

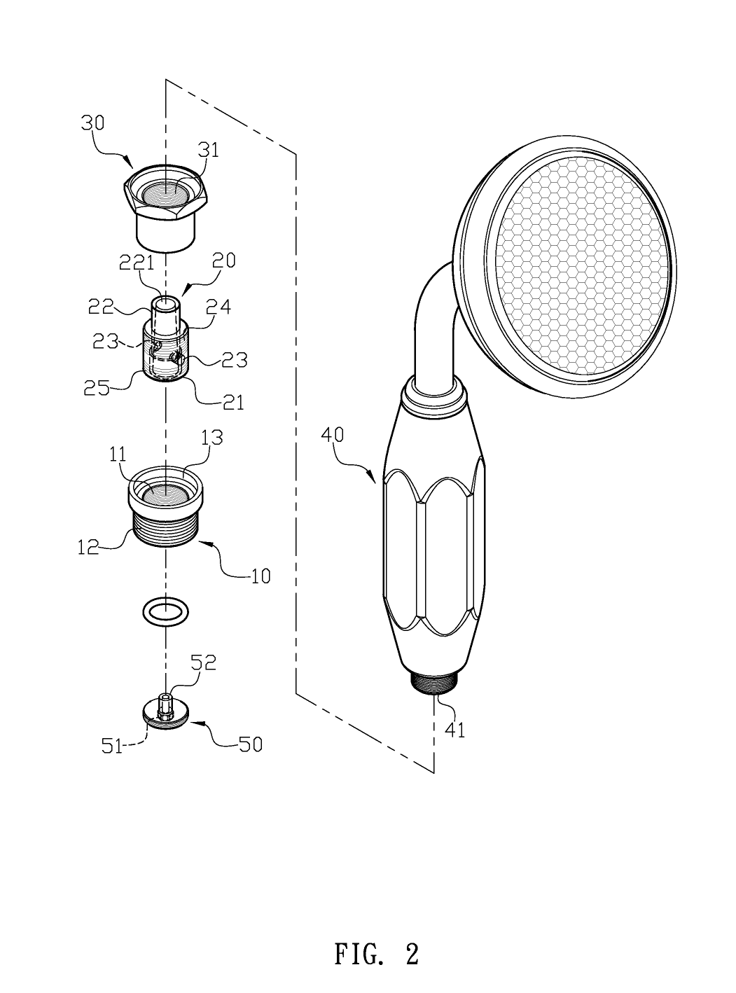

In yet a further embodiment, the connecting portion (12) of the connector (10) is an outer threaded section (as shown in FIGS. 1 and 2) to connect to the water source.

In a particular embodiment, the connecting portion (12) of the connector (10) is an inner threaded section (as shown in FIGS. 6 and 7) to connect to the water source.

In a preferred embodiment, the first connecting hole (11) of the connector (10) and the second engaging portion (25) of the mixing body (21) of the mixing unit (20) are formed into an inner threaded section and an outer threaded section to engage with each other.

In an advantage embodiment, a converging unit (50) is formed inside of the first connecting hole (11) of the connector (10), and an axle hole (51) axially penetrates a central portion of the converging unit (50). A converging tube (52) connected to the axle hole (51) is secured inside of the water channel (221) of the mixing unit (20).

Referring to FIG. 4, in actual application, the water flows from the connecting portion (12) of the connector (10), through the axle hole (51), the converging tube (52), and the water channel (221), into the shower head assembly and gushes out of the shower head assembly from the shower head (40). Since the through hole (13) has no contact with the mixing body (21) of the mixing unit (20), air can flow in a space between the through hole (12) and the mixing body (21) of the mixing unit (20). Also, Because of the design of the air holes (23), the air can be sucked into shower head (40) from the air holes (23) to prevent the inside of the shower head (40) from being vacuum state. Moreover, the air sucked into shower head (40) can scatter the water flow, so that the water gushed out of the shower head (40) can be in the form of water column with water spray. Thus, the range of water sprayed from the shower head (40) is wider, and the shower head assembly can be more effective to achieve the purpose of water-saving.

Comparing with conventional shower head assembly, the present invention is advantageous because: (i) since the diameter of the through hole (13) is larger than the first connecting hole (11), the air holes (23) can be covered to prevent the air holes (23) from being exposed outside of the shower head assembly. Thus, it not only improves the appearance of the shower head, but also prevents the air holes from blocking by dust or other stuff; and (ii) with the design of the connector (10), the mixing unit (20) combining the adapter unit (30), the shower head assembly of the present invention can apply in both the fixed shower head and the handheld shower head to improve the application of the shower head assembly.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A shower head comprising a connector, a mixing unit, an adapter unit and a shower head,
wherein a connector having a first connecting hole axially penetrating through a central portion of the connector, and an connecting portion formed at a first end of the connector to connect to the water source, wherein a through hole extending from the connecting hole being formed at a second end of the connector, and a diameter of the through hole being larger than the connecting hole, wherein the mixing unit comprising of a hollowed mixing body to allow a pipe to axially penetrate through a central portion of the mixing body, and a water channel formed inside of the pipe, wherein at least two air holes penetrating two relative positions of an outer periphery of the mixing body to connect to the water channel, and a first end of the pipe stuck out from a first end of the mixing body, also, a first engaging portion formed at the first end of the mixing unit, and a second engaging portion formed at a second end thereof, wherein in assembly process, the first engaging portion of the mixing unit engaged with the adapter unit to secure the pipe inside of the adapter unit, and then the second engaging portion secured inside of the connecting hole to connect the mixing unit to the connector, wherein since the diameter of the through hole being larger than the first connecting hole, the air holes can be covered to prevent the air holes from being exposed outside of the shower head assembly; and
a second connecting hole axially penetrating a central portion of the adapter unit to connect the adapter unit with the shower head and the mixing unit with the connector, since the pipe protruding from the adapter unit after connecting the mixing unit with the connector to the adapter unit, the water channel can be connected to an inner water channel of the shower head.

2. The shower head assembly of claim 1, in one embodiment, wherein said shower head can be applied in a handheld shower head assembly, and the first engaging portion of the mixing unit is a threaded section formed at the outer periphery of the mixing unit, and the first engaging portion of the adapter unit is a threaded section formed at an inner periphery thereof.

3. The shower head assembly of claim 1, in another embodiment, wherein said shower head can be applied in a fixed shower head assembly, and the first engaging portion is a ball body secured around the pipe.

4. The shower head assembly of claim 1, wherein the through hole of the connector is shaped into a stepped shape.

5. The shower head assembly of claim 1, wherein the through hole of the connector is shaped into a tapered shape.

6. The shower head assembly of claim 1, wherein a diameter of an inlet of the water channel is larger than an outlet thereof to form a tapered water channel.

7. The shower head assembly of claim 1, wherein the first connecting hole of the connector and the second engaging portion of the mixing body of the mixing unit are formed into an inner threaded section and an outer threaded section to engage with each other.

8. The shower head assembly of claim 1, wherein a converging unit is formed inside of the first connecting hole of the connector, and an axle hole axially penetrates a central portion of the converging unit, and a converging tube protruding from the axle hole is connected with the axle hole.
